(19) United States
(12) Patent Application Publication
(10) Pub. No.: US 2004/0010475 A1
(43) Pub. Date: Jan. 15, 2004

(54) Systems and methods for processing high volume mailings

(76) Inventor: Jeffrey Soltis, Schaumburg, IL (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/311,017

(22) PCT Filed: Mar. 15, 2002
(86) PCT No.: PCT/US02/08028

(51) Int. Cl. G06F 17/60

(52) U.S. Cl. 705/401; 705/409

(57) ABSTRACT

At least one listing from a mailer of packages deposited in at least one post office is received by a verification system. The at least one listing further comprises, for each package deposited, a corresponding package identification code and a corresponding computed postage. The verification system receives from the mailer a total postage payment equal to the sum of the computed postage for each package deposited. The verification system determines a sample of the packages deposited and verifies postage for the sample of the packages deposited. The verification system determines an additional payment for the mailer based on the verification.

### CROSS-REFERENCE TO RELATED APPLICATION

This application claims the priority benefit of U.S. Provisional Application No. 60/275,637, filed on Mar. 15, 2001, which is incorporated herein by reference.

### FIELD

The present invention relates generally to systems and methods for processing high volume mailings.

### BACKGROUND

Traditionally, to verify postage for high volume mailers, a mailer provides a post office with a listing of each package deposited at the post office, a postage computation by the mailer for each package deposited, and a unique package identifier for each package deposited. A listing is submitted separately to each post office where the mailer deposits packages. Each listing is provided on one or more sheets of paper. Therefore, this process generates a lot of paperwork. Each post office must manually verify the postage for each package or a sample of the packages deposited. That is, each post office manually compares the actual postage and the computed postage for each package or sample of the packages deposited and then manually computes any additional postage required to be paid. The actual postage for a package is determined by placing the package on a scale, reviewing a rate chart, and reviewing a zone chart. This process is labor intensive and time consuming.

Accordingly, there is a need for systems and methods for processing high volume mailings that minimize or eliminate the amount of paperwork generated and decreases the processing time to verify postage.

### SUMMARY

In accordance with the invention, this is provided a method for processing high volume mailings. Further, in accordance with the invention, there is provided a computer readable medium containing instructions for controlling a computer system to perform the method. The method comprises receiving at least one listing from a mailer of packages deposited in at least post office, wherein the at least one listing further comprises, for each package deposited, a corresponding package identification code and a corresponding computed postage. The method also comprises receiving a total postage payment from the mailer, wherein the total postage payment equals the sum of the computed postage for each package deposited. Further, the method comprises determining a sample of the packages deposited and verifying postage for the sample of the packages deposited. Still further, the method comprises determining an additional payment for the mailer based on the verification.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

In the drawings:

FIG. 1 illustrates an environment for processing high volume mailings consistent with the present invention.

FIG. 2 illustrates a method of processing high volume mailings consistent with the present invention.

FIG. 3 illustrates the method of processing high volume mailings from a viewpoint of a post office.

FIG. 4 a method of verifying postage for a sample of packages deposited and determining additional payment.

### DESCRIPTION OF THE EMBODIMENTS

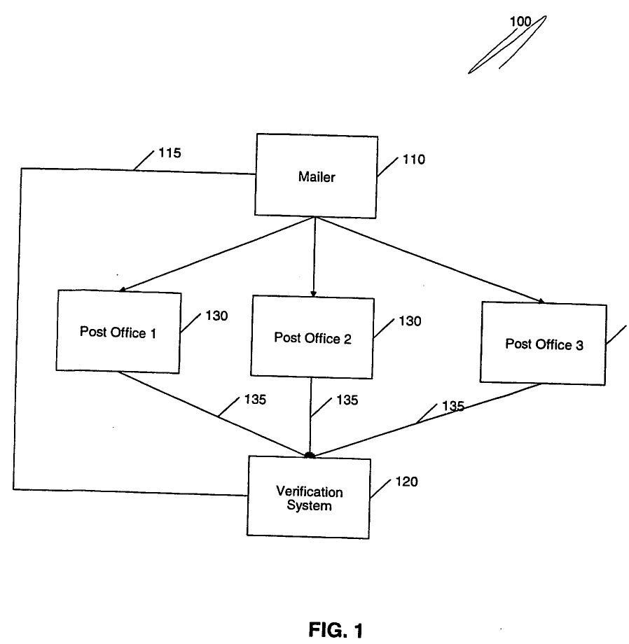

Referring now to the drawings, in which the same reference numbers are used to refer to the same or like parts, FIG. 1 illustrates an environment 100 for processing high volume mailings. Environment 100 comprises a mailer 110, a verification system 120, and one or more post offices 130. In one embodiment, mailer 110 is a person, business, or association that deposits packages in a mailing system such as the United State Postal Service consistently and in high volume sufficient for the verification system 120 to develop a statistically valid sampling plan. The term package as used in this application means any item capable of being delivered in a mailing system (e.g., a letter or a parcel). Post offices 130 may be located anywhere in the mailing system. For example, post offices 130 may be located in different states or countries. Verification system 120 includes a processor (not shown) comprising computer instructions for implementing embodiments consistent with the present invention.

Mailer 110 may transmit information to verification system 120 via a connection 115. Post offices 130 may transmit information to verification system 120 via connections 135. Connections 115, 135 may be any system, network, or device that facilitates communication (e.g., data communication or telecommunication) using any appropriate communication protocol (e.g., TCP/IP, HTTP, HTTPS or any other security protocol, FTP, SMTP, or any other proprietary protocol). Connections 115, 135 may comprise a local area network (LAN) connection, a wide area network (WAN) connection, an Internet connection, or a combination of the foregoing. Connections 115, 135 may comprise a telephone line, optical fiber, coaxial cable, twisted wire pair, or a combination of the foregoing. Connections 115, 135 may be wireless using any technique to provide wireless transmission including infrared line of sight, cellular, microwave, satellite, packet radio, spread spectrum, or a combination of the foregoing.

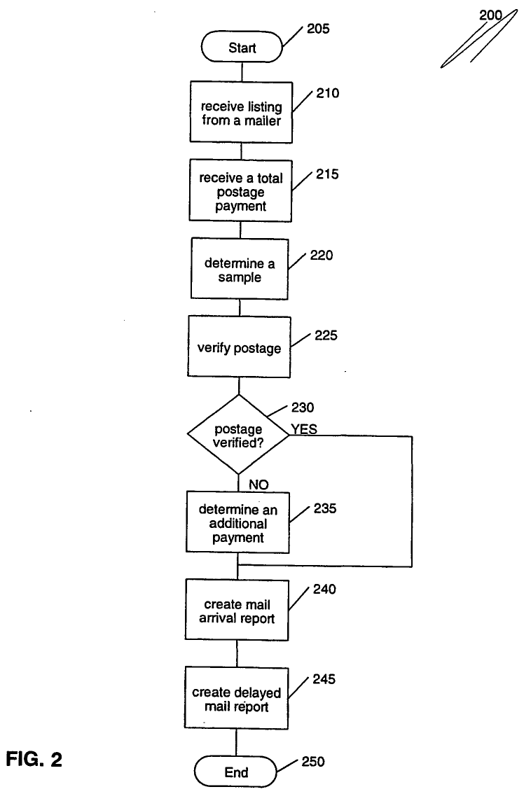

FIG. 2 illustrates a method 200 of processing high volume mailings consistent with the present invention. Mailer 110 prepares a listing of packages to be deposited in one or more post offices 130. For each package to be deposited in post offices 130, the mailer 110 computes a postage for the package. The computed postage for each package to be deposited may include postage plus additional service fees for services such as certified mail, return receipt, delivery conformation, certificate of mailing, insured mail, or registered mail. The mailer transmits the listing of the packages and the corresponding computed postage for each package to verification system 120. The listing may further comprise, for each package, a unique package identification number, weight information, destination information, service information, a date of mailing, and/or entry post office information. The entry post office is the post office where the package is delivered.

At stage 210, verification system 120 receives the listing from mailer 110. In one embodiment, verification system 120 receives the listing from mailer 110 electronically via the connection 115.

At stage 215, verification system 120 may receive a total postage payment from mailer 110. The total postage payment may equal the sum of the computed postage for each package deposited. In one embodiment, verification system 120 receives the total postage payment by electronically debiting an account owned by mailer 110.

The mailer 100 deposits the packages at one or more post offices 130. Each package may include information on its exterior in the form of a barcode for example. The information on the exterior of each package may include the package identification number, the weight information, the destination information, the service information, and/or the date of mailing as provided in the listing.

At stage 220, verification system 120 determines which packages deposited by mailer 100 will be verified for postage. Selected ones of the packages deposited by mailer 100 that are determined to be verified for postage are referred to as the “sample of the packages deposited.” The sample may be all, a percentage, or a predetermined number of packages deposited at a particular post office of one or more post offices 130. The particular post office may be randomly selected periodically (e.g., daily, weekly, or monthly) based on mailer's 100 mailing pattern.

Once the sample has been determined, at stage 225, verification system 120 verifies the postage for the sample of packages deposited. In one embodiment, verification system 120 verifies the postage for the sample of packages deposited based on information received from one or more post offices 130.

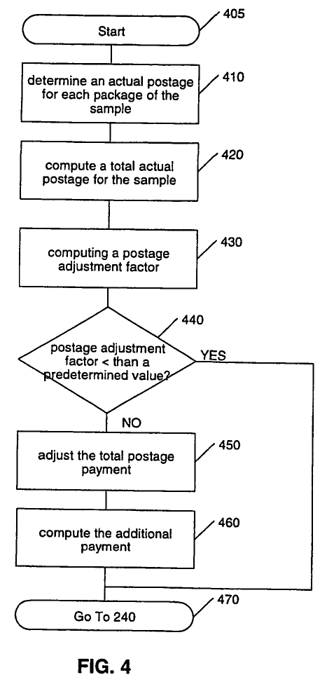

Referring to FIG. 4, first, at stage 410, verification system 120 determines the actual postage for each package of the sample of packages deposited. As explained below, for each package of the sample of packages deposited, post office 130 where the package was deposited either transmits the postage of the package or transmits sufficient information to enable the verification system 120 to compute the postage of the package. Second, at stage 420, verification system 120 computes the total actual postage for the sample of packages by totaling the actual postage for each package of the sample of packages deposited. Third, the verification system 120 compares the total actual postage for the sample of packages to a total computed postage for the sample of packages. The total computed postage may equal the sum of the computed postage for each package of the sample. In one embodiment the verification system 120 compares the total actual postage to the total computed postage by computing a postage adjustment factor and determining whether the postage adjustment factor is less than a predetermined value, as illustrated at stage 430, 440. The postage adjustment factor may equal the total actual postage divided by the total computed postage. In one embodiment, the predetermined value is 1.5.

At stage 230, verification system 120 determines whether to verify the postage for the sample of packages deposited. If the comparison, at stage 225, of the total actual postage to the total computed postage is within an acceptable limit, then the postage for the sample of packages is considered to be verified (i.e., “YES” at stage 230). In one embodiment, as illustrated at stage 440, if the adjustment factor is less than a predetermined value (i.e., “YES” at stage 440), then the postage for the sample of packages is verified. If the comparison, at stage 225, of the total actual postage to the total computed postage is not within an acceptable limit, then the postage for the sample of packages is not verified (i.e., “NO” at stage 230). Therefore, at stage 235, verification system 120 determines an additional payment for the mailer 110. For example, the additional payment may be determined by adjusting the total postage payment by the postage adjustment factor at stage 450. At stage 460, verification system 120 may compute the additional payment as the difference between the adjusted total postage payment and the total postage payment. The verification system 120 may receive the additional payment by electronically debiting the account owned by mailer 110.

At stage 240, the verification system 120 may create a mail arrival report based on information received from post offices 130 at stage 340. The mail arrival report list arrival information for packages deposited at post offices 130. At stage 245, the verification system may create a delayed mail report. The delayed mail report may list information related to the time lapse between when the verification system 120 received the listing and when a package on the list was deposited at one of post offices 130. Alternatively, the delayed mail report may list information related to the time lapse between the date of mailing provided on the list for a package and when the package was deposited at one of post offices 130.

In an alternative embodiment of method 200, at stage 210, verification system 120 may receive, for each day during an accounting period (e.g., 28 days) in which the mailer 110 deposits packages in one or more post offices 130, a listing from mailer 110 of the packages deposited at the one or more post offices 130 for the day. At stage 210 the total postage payment is for the entire accounting period. At stage 220, the sample is determined throughout the accounting period. At stage 225, the verification system 120 verifies the postage for the sample of packages deposited during the accounting period. At stage 235, the additional payment is determined based on the accounting period. For example, the total postage payment for the entire accounting period may be adjusted by the postage adjustment factor.

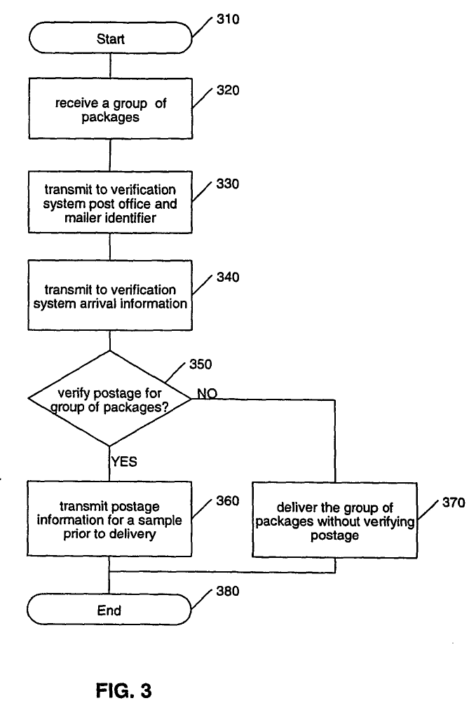

FIG. 3 illustrates the method of processing high volume mailings from the viewpoint of each post office 130. At stage 320, post office 130 receives a group of packages from mailer 110. At stage 330, post office 130 may transmit a post office identifier and a mailer identifier to verification system 120 to inform verification system 120 that mailer 110 has deposited mail at the post office 130. The post office identifier may be any information that identifies the post office 130 and/or its location.

At stage 340, post office 130 may scan one package of the group of packages to retrieve a package identification number. Post office 130 may transmit the package identification number and other arrival information (e.g., date and time) to verification system 130 to inform verification system 120 that the group of packages corresponding to the package identification number has arrived at post office 130. This information may be used by verification system 120 to create a mail arrival report and a delayed mail report, as discussed above.

At stage 350, post office 130 determines whether to verify postage for the group of packages received at stage 320 based on the determination made at stage 220. If the verification system 120 determined at stage 220 that the packages deposited at the post office 130 where to be verified (i.e., “YES” at stage 350), then the post office 130 transmits to verification system 120 postage information for a sample of the group of packages prior to delivery of the packages to their destination. The postage information may be the postage for each package of the sample of the group of packages. Alternatively, the postage information may be sufficient information to enable the verification system 120 to compute the postage for each package of the sample of the group of packages. For example, the post office 130 may transmit to verification system 120 weight information for each package of the sample of the group of packages. The post office 130 may also transmit to verification system 120 destination information for each package of the sample of the group of packages. Further, the post office 130 may transmit to verification system 120 information relating to the location of post office 130. The information relating to the location of post office 130 may be a zip code, for example, or a post office identifier. If the information relating to the location of post office 130 is a post office identifier, then verification system 120 may be able to determine the location of the post office 130 by cross-referencing the post office identifier with a location. Still further, the post office 130 may transmit to verification system 120 information relating to services (e.g., certified mail, return receipt, delivery conformation, certificate of mailing, or registered mail) requested for each package of the sample of the group of packages.

If the verification system 120 determined at stage 220 that the packages deposited at the post office 130 where not to be verified (i.e., “NO” at stage 350), then the post office 130 delivers the group of packages to their destination without verifying postage at stage 370.

The systems and methods of the present invention provide electronic postage documentation, payment, verification. The systems and methods of the present invention reduce or eliminate paperwork required for processing large volume mailings. The systems and methods of the present invention also reduce the processing time to verify postage. Further, the systems and methods of the present invention provide the mailer with feedback regarding packages deposited and the accuracy of its devices for computing postage.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing high volume mailings comprising:
receiving at least one listing from a mailer of packages deposited in at least one post office, wherein the at least one listing further comprises, for each package deposited, a corresponding package identification code and a corresponding computed postage;
receiving a total postage payment from the mailer, wherein the total postage payment equals the sum of the computed postage for each package deposited;
determining a sample of the packages deposited;
verifying postage for the sample of the packages deposited; and
determining an additional payment for the mailer based on the verification.

2. The method according to claim 1, wherein receiving at least one listing comprises receiving an electronic file of the at least one listing.

3. The method according to claim 1, wherein receiving a total postage payment comprises electronically debiting an account based on the total postage payment.

4. The method according to claim 1, wherein verifying postage comprises:
determining an actual postage for each package of the sample;
computing a total actual postage for the sample, wherein the total actual postage equals the sum of the actual postage for each package of the sample; and
comparing the total actual postage for the sample to a total computed postage for the sample, wherein the total computed postage equals the sum of the computed postage for each package of the sample.

5. The method according to claim 4, wherein determining an actual postage for each package of the sample comprises:
receiving weight information for each package of the sample;
receiving destination information for each package of the sample; and
receiving a post office location for each package of the sample.

6. The method according to claim 4, wherein comparing the total actual postage for the sample to a total computed postage for the sample comprises:
computing a postage adjustment factor equal to the total actual postage for the sample divided by the total computed postage for the sample; and
determining whether the postage adjustment factor is less than a predetermined value.

7. The method according to claim 6, wherein determining an additional payment from the mailer based on the verification, comprises:
adjusting the total postage payment by the postage adjustment factor and
computing the additional payment based on the total postage payment and the adjusted total postage payment.

8. The method according to claim 1, the method further comprising:
receiving for each group of packages deposited at a post office, information relating to a location of the post office; and
determining whether the mailer paid postage for the group of packages deposited at the post office.

9. The method according to claim 8, wherein determining whether the mailer paid postage comprises:
receiving the at least one listing from the mailer wherein the at least one listing further comprises, for each package deposited, a corresponding post office identifier; and
determining whether there exists in the at least one listing a post office identifier corresponding to the information received relating to the location of the post office.

10. The method according to claim 1, the method further comprising:
receiving, for each group of packages received at a post office, information relating to when the group of packages arrived at the post office; and
creating a mail arrival report for each group of packages received at a post office, based on the information relating to when the group of packages arrived at the post office.

11. The method according to claim 10, wherein the information relating to when the group of packages arrived at the post office comprises:
a time and date at least one package of the group of packages is scanned; and
a package identifier for the at least one package.

12. The method according to claim 11, the method further comprising creating a delayed mail report for each group of packages received at a post office, based on the information relating to when the group of packages arrived at the post office and when the at least one listing was received.

13. A computer readable medium containing instructions for controlling a computer system to perform a method, the method comprising:
receiving at least one listing from a mailer of packages deposited in at least one post office, wherein the at least one listing further comprises, for each package deposited, a corresponding package identification code and a corresponding computed postage;
receiving a total postage payment from the mailer, wherein the total postage payment equals the sum of the computed postage for each package deposited;
determining a sample of the packages deposited;
verifying postage for the sample of the packages deposited; and
determining an additional payment for the mailer based on the verification.

14. The computer readable medium of claim 13, wherein receiving at least one listing comprises receiving an electronic file of the at least one listing.

15. The computer readable medium of claim 13, wherein receiving a total postage payment comprises electronically debiting an account based on the total postage payment.

16. The computer readable medium of claim 13, wherein verifying postage comprises:
determining an actual postage for each package of the sample;
computing a total actual postage for the sample, wherein the total actual postage equals the sum of the actual postage for each package of the sample; and
comparing the total actual postage for the sample to a total computed postage for the sample, wherein the total computed postage equals the sum of the computed postage for each package of the sample.

17. The computer readable medium of claim 16, wherein determining an actual postage for each package of the sample comprises:
receiving weight information for each package of the sample;
receiving destination information for each package of the sample; and
receiving a post office location for each package of the sample.

18. The computer readable medium of claim 16, wherein comparing the total actual postage for the sample to a total computed postage for the sample comprises:
computing a postage adjustment factor equal to the total actual postage for the sample divided by the total computed postage for the sample; and
determining whether the postage adjustment factor is less than a predetermined value.

19. The computer readable medium of claim 18, wherein determining an additional payment from the mailer based on the verification, comprises:
adjusting the total postage payment by the postage adjustment factor and
computing the additional payment based on the total postage payment and the adjusted total postage payment.

20. The computer readable medium of claim 13, the method further comprising:
receiving for each group of packages deposited at a post office, information relating to a location of the post office; and
determining whether the mailer paid postage for the group of packages deposited at the post office.

21. The computer readable medium of claim 20, wherein determining whether the mailer paid postage comprises:
receiving the at least one listing from the mailer wherein the at least one listing further comprises, for each package deposited, a corresponding post office identifier; and
determining whether there exists in the at least one listing a post office identifier corresponding to the information received relating to the location of the post office.

22. The computer readable medium of claim 13, the method further comprising:
receiving, for each group of packages received at a post office, information relating to when the group of packages arrived at the post office; and
creating a mail arrival report for each group of packages received at a post office, based on the information relating to when the group of packages arrived at the post office.

23. The computer readable medium of claim 22, wherein the information relating to when the group of packages arrived at the post office comprises:
a time and date at least one package of the group of packages is scanned; and
a package identifier for the at least one package.

24. The computer readable medium of claim 23, the method further comprising creating a delayed mail report for each group of packages received at a post office, based on the information relating to when the group of packages arrived at the post office and when the at least one listing was received.

25. A method of processing high volume mailings wherein a mailer deposits groups of packages at a plurality of post offices comprising:
receiving the groups of packages at the plurality of post offices;
transmitting postage information for at least one group of packages to a verification system prior to delivering each package of the at least one group of packages; and
delivering each package of the remaining groups of packages without verifying postage.

26. The method according to claim 25, wherein transmitting postage information for at least one group of packages to a verification system prior to delivering each package of the at least one group of packages comprises:
transmitting weight information of each package of a sample of the at least one group of packages to the verification system;
transmitting destination information for each package of the sample to the verification system; and
transmitting a post office location for each package of the sample to the verification system.

27. A method according to claim 25, further comprising:
receiving at least one listing from the mailer of packages deposited in at least one post office, wherein the at least one listing further comprises, for each package deposited, a corresponding package identification code and a corresponding computed postage;
receiving a total postage payment from the mailer, wherein the total postage payment equals the sum of the computed postage for each package deposited; and
verifying postage for the sample; and
determining an additional payment from the mailer based on the verification.

28. The method according to claim 27, wherein receiving at least one listing comprises receiving an electronic file of the at least one listing.

29. The method according to claim 27, wherein receiving a total postage payment comprises electronically debiting an account based on the total postage payment.

30. The method according to claim 27, wherein verifying postage comprises:
determining an actual postage for each package of the sample based on the weight information, the destination information, and the post office location for each package;
computing a total actual postage for the sample, wherein the total actual postage equals the sum of the actual postage for each package of the sample; and
comparing the total actual postage for the sample to a total computed postage for the sample, wherein the total computed postage equals the sum of the computed postage for each package of the sample.

31. The method according to claim 30, wherein comparing the total actual postage for the sample to a total computed postage for the sample comprises:
computing a postage adjustment factor equal to the total actual postage for the sample divided by the total computed postage for the sample; and
determining whether the postage adjustment factor is less than a predetermined value.

32. The method according to claim 31, wherein determining an additional payment from the mailer based on the verification, comprises:
adjusting the total postage payment by the postage adjustment factor and computing the additional payment based on the total postage payment and the adjusted total postage payment.

33. The method according to claim 27, further comprising:
transmitting to the verification system, for each group of packages received at a post office, information relating to a location of the post office; and
determining whether the mailer paid postage for the group of packages received at the post office.

34. The method according to claim 33 wherein determining whether the mailer paid postage comprises:
receiving the at least one listing from the mailer wherein the at least one listing further comprises, for each package deposited, a corresponding post office identifier; and
determining whether there exists in the at least one listing a post office identifier corresponding to the information transmitted to the verification system relating to the location of the post office.

35. The method according to claim 27, further comprising:
transmitting to the verification system, for each group of packages received at a post office, information relating to when the group of packages arrived at the post office; and
creating a mail arrival report for each group of packages received at a post office, based on the information relating to when the group of packages arrived at the post office.

36. The method according to claim 35, wherein the information relating to when the group of packages arrived at the post office comprises:
a time and date at least one package of the group of packages is scanned; and
a package identifier for the at least one package.

37. The method according to 36, further comprising:
creating a delayed mail report for each group of packages received at a post office, based on the information relating to when the group of packages arrived at the post office and when the at least one listing was received.

38. A method for processing high volume mailings comprising:
receiving, for each day during an accounting period in which a mailer deposits packages in at least one post office, a listing from the mailer of the packages deposited at the at least one post office for the day, wherein the listing further comprises, for each package deposited, a corresponding package identification code and a corresponding computed postage;
receiving a total postage payment from the mailer, wherein the total postage payment equals the sum of the computed postage for each package deposited during the accounting period;
determining a sample of the packages deposited during the accounting period;
verifying postage for the sample of the packages deposited during the accounting period; and
determining an additional payment for the mailer based on the verification.

39. The method according to claim 38, wherein receiving a listing comprises receiving an electronic file of the listing.

40. The method according to claim 38, wherein receiving a total postage payment comprises electronically debiting an account based on the total postage payment.

41. The method according to claim 38, wherein verifying postage comprises:
determining an actual postage for each package of the sample;
computing a total actual postage for the sample, wherein the total actual postage equals the sum of the actual postage for each package of the sample; and
comparing the total actual postage for the sample to a total computed postage for the sample, wherein the total computed postage equals the sum of the computed postage for each package of the sample.

42. The method according to claim 41, wherein determining an actual postage for each package of the sample comprises:
receiving weight information for each package of the sample;
receiving destination information for each package of the sample; and
receiving a post office location for each package of the sample.

43. The method according to claim 41, wherein comparing the total actual postage for the sample to a total computed postage for the sample comprises:
computing a postage adjustment factor equal to the total actual postage for the sample divided by the total computed postage for the sample; and
determining whether the postage adjustment factor is less than a predetermined value.

44. The method according to claim 43, wherein determining an additional payment from the mailer based on the verification comprises:
adjusting the total postage payment by the postage adjustment factor; and
computing the additional payment based on the total postage payment and the adjusted total postage payment.

45. A computer readable medium containing instructions for controlling a computer system to perform a method, the method comprising:
receiving, for each day during an accounting period in which a mailer deposits packages in at least one post office, a listing from the mailer of the packages deposited at the at least one post office for the day, wherein the listing further comprises, for each package deposited, a corresponding package identification code and a corresponding computed postage;
receiving a total postage payment from the mailer, wherein the total postage payment equals the sum of the computed postage for each package deposited during the accounting period;
determining a sample of the packages deposited during the accounting period;
verifying postage for the sample of the packages deposited during the accounting period; and
determining an additional payment for the mailer based on the verification.

46. The computer readable medium of claim 45, wherein receiving a listing comprises receiving an electronic file of the listing.

47. The computer readable medium of claim 45, wherein receiving a total postage payment comprises electronically debiting an account based on the total postage payment.

48. The computer readable medium of claim 45, wherein verifying postage comprises:
determining an actual postage for each package of the sample;
computing a total actual postage for the sample, wherein the total actual postage equals the sum of the actual postage for each package of the sample; and
comparing the total actual postage for the sample to a total computed postage for the sample, wherein the total computed postage equals the sum of the computed postage for each package of the sample.

49. The computer readable medium of claim 48, wherein determining an actual postage for each package of the sample comprises:
receiving weight information for each package of the sample;
receiving destination information for each package of the sample; and
receiving a post office location for each package of the sample.

50. The computer readable medium of claim 48, wherein comparing the total actual postage for the sample to a total computed postage for the sample comprises:
computing a postage adjustment factor equal to the total actual postage for the sample divided by the total computed postage for the sample; and
determining whether the postage adjustment factor is less than a predetermined value.

51. The computer readable medium of claim 50, wherein determining an additional payment from the mailer based on the verification comprises:
adjusting the total postage payment by the postage adjustment factor; and
computing the additional payment based on the total postage payment and the adjusted total postage payment.
